(19) United States
(12) Patent Application Publication
(10) Pub. No.: US 2006/0114349 A1
(43) Pub. Date: Jun. 1, 2006

(54) Video camera

(75) Inventor: Gen Okazaki, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/259,211

(22) Filed: Oct. 25, 2005

(30) Foreign Application Priority Data
Nov. 30, 2004 (JP) 2004-345110

(51) Int. Cl. H04N 5/225

(52) U.S. Cl. 348/374

(57) ABSTRACT

In a video camera using an optical disk, if a lock mechanism of an open and close cover for exchanging the optical disk exists in an upper part, the camera becomes taller by the height corresponding to the lock mechanism. Further, in the case that one lock mechanism is provided at an intermediate position (cantilever), the open and close cover opens by its own weight and makes a gap. A video camera of the invention comprises a drive device to mount an optical disk, an open and close cover to be opened and closed using a hinge mechanism when the optical disk is exchanged, and a lock mechanism comprised of a plurality of lock hooks and one or more lock devices to lock the open and close cover, and is characterized in that a position of the lock mechanism is equal to or lower than a height of an end face of the optical disk on the side opposite to the hinge mechanism when the optical disk is mounted to the drive device.

### INCORPORATION BY REFERENCE

The present application claims priority from Japanese application JP-A-2004-345110 filed on Nov. 30, 2004 the content of which is hereby incorporated by reference into this application.

### BACKGROUND OF THE INVENTION

The present invention relates to a video camera.

A background art in this technical field is shown in, for example, JP-A-2004-214752. This publication has, concerning a problem to be solved, a description “An object is to reduce the size of a photographing device for recording information in an optical disk-shaped recording medium”. The publication further describes a solving means as “a construction adopted to insert and draw an optical disk vertically with respect to a photographing direction”.

Another background art in this technical field is shown in, for example, JP-A-2000-113660. This publication describes a problem to be solved as “making a device body compact and thin and facilitating attachment and detachment of a disk-shaped recording medium”. This publication further has, concerning a means for solving, a description “This comprises a device body 3 with a disk receiving portion 6 for receiving an optical disk 2 and a cover 4 which is formed in almost the same size as the disk receiving portion 6, which has an outer peripheral wall 24 formed on its outer periphery to be brought into contact with a bottom face of the disk receiving portion 6 and which is rotatably supported on the device body 3 for opening and closing the disk receiving portion 6. Operation recesses 31 and 41 are provided on a casing 5 forming the device body 3, which lie adjacent the outer peripheral wall 24 of the cover 4 and lay part of the outer peripheral wall 24 of the cover 4 open to the outside when the cover 4 closes the disk receiving portion 6 and which fingers of a hand hook to detach the optical disk 2 from the disk receiving portion 6”.

### SUMMARY OF THE INVENTION

In recent years, a video camera using an optical disk capable of random access and having large capacity storage performance (hereinafter simply referred to as video camera) has been commercialized.

The construction of such a video camera is ordinarily divided into a front side having a camera lens for taking in video information to be photographed and a microphone unit, a liquid crystal display side having a liquid crystal display unit rotatable for opening and closing, a grip side formed of an open and close cover to be opened and closed when an optical disk is exchanged and a case covering a recording unit (a drive unit), and a rear side having a view finder and a battery attachment portion, and component parts and outer casings are arranged in the respective sides. In addition, the direction of inserting the optical disk is designed to be perpendicular to the video camera body to realize thinning of the video camera. When an object is photographed, the grip side is held by one hand and the lens side is aimed at the object to photograph.

It is desired that there is no case wherein a user accidentally falls an optical disk and the optical disk is damaged when the optical disk as a recording medium is exchanged. To this end, there is a video camera in which a supporting point (hinge mechanism) of an open and close cover is disposed in a lower part of a video camera body and an upper side is opened and closed, thereby preventing an optical disk from falling.

In this video camera, a lock mechanism for the open and close cover is disposed on the opposite end side to the hinge mechanism, that is, in an upper part of the video camera body. This results in the height of the open and close cover becoming the height that the outer dimension of the optical disk and the sizes of members constituting the lock mechanism are summed (an increase in size). Thus, the height of the video camera increases by the size corresponding to the lock mechanism, and it is hard to further reduce the height of the video camera.

In view of the above, in disk drive devices using a CD (Compact Disk), an MD (Mini Disk) or the like, there was a technique of providing a construction in which no lock mechanism was installed on the opposite end side to the hinge mechanism of an open and close cover, more specifically, a device in which a lock mechanism was disposed at an intermediate position between the opposite end to the hinge mechanism and the hinge mechanism. In this conventional device, a disk is used horizontally, and force acts due to the own weight of the open and close cover in the direction of closing the open and close cover even when no lock mechanism is provided on the opposite end side to the hinge mechanism, and a gap is scarcely made.

However, in the case of the above described video camera, because of the construction in which the direction of receiving the optical disk is perpendicular to the camera body and the upper side of the camera body is opened and closed, the open and close cover is subject to force in a direction of opening due to its own weight. Therefore, there is a problem that the side on which no lock mechanism exists is opened by its own weight to make a gap. If a gap is made, dust or the like is easy to enter from the gap and there is possibility that a problem will arise in the performance of the optical disk. Further, the quality of the appearance becomes inferior.

The present invention therefore has an object of improving the usability of a video camera.

The above object is achieved by the invention defined in accompanying claims.

According to the invention, the usability of a video camera can be improved.

### BRIEF DESCRIPTION OF THE DRAWINGS

These and other features, objects and advantages of the present invention will become more apparent from the following description when taken in conjunction with the accompanying drawings wherein:

FIG. 1 is a rear perspective view of a video camera according to an embodiment of the invention in a state wherein a disk cover is opened;

FIG. 2 is a front perspective view of the video camera according to the embodiment;

FIG. 3 is a sectional view of the video camera according to the embodiment;

FIG. 4 are enlarged views of a lock mechanism of the video camera according to the embodiment;

FIG. 5 are views of the lock mechanism of the video camera according to the embodiment as viewed from above; and

FIG. 6 is a conceptual view of the embodiment.

### DETAILED DESCRIPTION OF THE PREFERRED EMBODIMENT

The video camera according to the embodiment of the invention will be now described with reference to FIGS. 1 to 5.

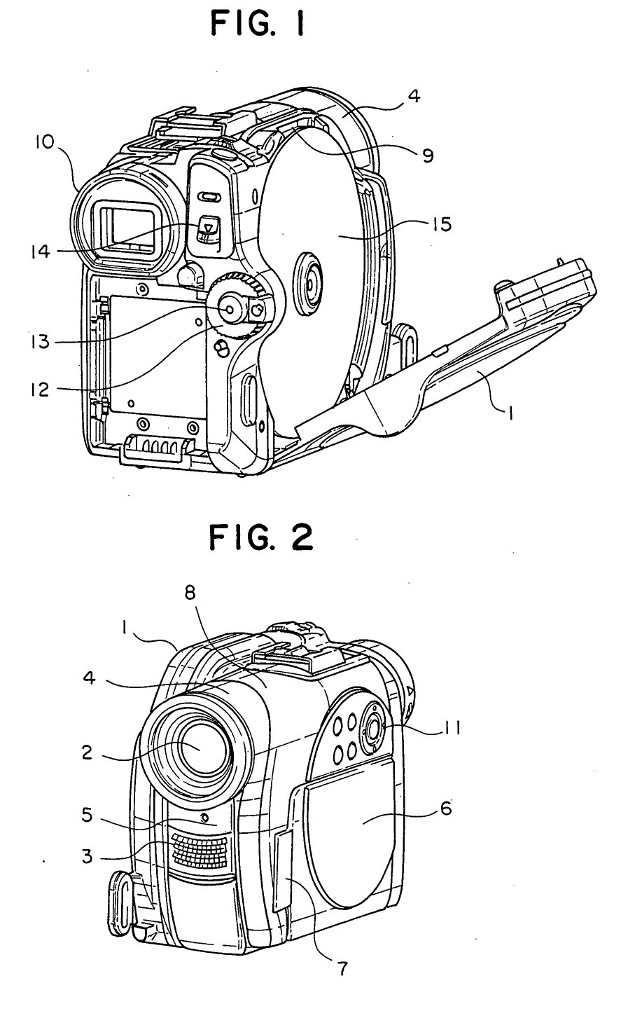

At the outset, the construction of the video camera according to the embodiment will be described with reference to FIGS. 1 and 2. FIG. 1 is the rear perspective view of the video camera according to the embodiment in the state wherein the disk cover is opened. FIG. 2 is the front perspective view of the video camera according to the embodiment.

The video camera according to the embodiment is constructed to be divided into a front side comprised of a lens unit 2 for taking a video image, a microphone unit 3 for collecting sounds, a lens cover 4, a front case 5 and so on, a liquid crystal display side comprised of an LCD (Liquid Crystal Display) unit 6 for displaying a video image or the like at the time of photographing and playback, an LCD support portion 7, a main body case 8 and so on, a grip side comprised of a disk cover 1, an R case 9 and so on, and a rear side comprised of an EVF (Electric View Finder) unit 10 for displaying a video image or the like at the time of photographing and playback, a battery (not shown) and so on.

The LCD unit 6 can be opened, closed and rotated with the LCD support portion 7 and is adjustable to an angle suitable for a use state. A playback operation button 11 to be used mainly at the time of playback is disposed on a face neighboring the LCD unit 6 when the latter is closed. A mode selection knob 12 provided on the rear side is for turning on and off power supply and for changing over between a motion picture mode and a still picture mode. A record button 13 is a start/stop button for recording. The R case 9 on the grip side protects a drive unit 18 for recording on an optical disk 15.

When a hook of a hook plate disposed on a back face of the disk cover 1, which will be described later, is engaged with a lock device disposed on a back face of the R case 9, which will be described later, through a hole opening in the R case 9, the disk cover 1 is held in a locked state. When the optical disk 15 is exchanged, the disk cover 1 on the grip side is opened by operating a takeout knob 14, and thereby the optical disk 15 is exposed and becomes exchangeable. Because the disk cover 1 is thus constructed to open upward, the optical disk 15 can be prevented from falling by accident.

The construction is such that a photographer holds the camera by his one hand with his or her fingers put on the disk cover 1 and the R case 9 of the grip side and aims the lens unit 2 at an object to be photographed, and therefore the optical disk 15 is arranged vertically. This makes the width of the video camera thin. As will be seen also from FIG. 2, the height of this video camera depends on the heights of the disk cover 1 and the R case 9.

Description will be now made on the lock mechanism which can lower the heights of the disk cover 1 and the R case 9 for a decrease in height.

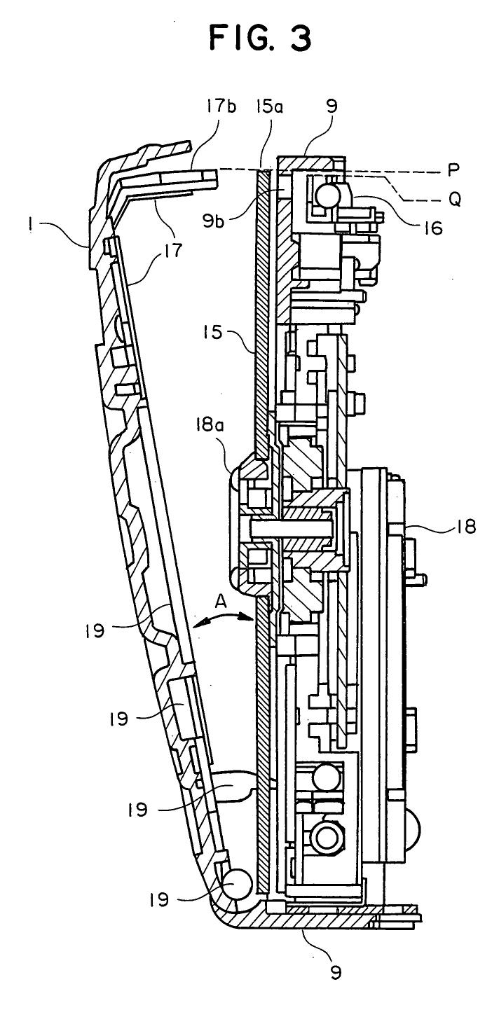

The arrangement of the lock mechanism according to this embodiment will be described with reference to FIG. 3. FIG. 3 is the sectional view of the grip side such as the disk cover which is an example of a protection portion for the drive device and the dick of the video camera according to the embodiment. FIG. 3 shows a state wherein the disk cover 1 is opened by about ten degrees.

The drive unit 18 has the lock device 16 disposed at its upper part and is fixed to the R case 9. The optical disk 15 is mounted to an attachment portion 18a at a center of the drive unit 18. The disk cover 1 and the hook plate 17 are fixed, and further the disk cover 1 and a hinge 19 are also fixed. When the hinge 19 is moved in an A direction, the hook plate 17 and the disk cover 1 fixed to the hinge 19 move for opening and closing. When the disk cover 1 is closed, the hook 17b on a front end portion of the hook plate 17, which is an example of an engagement portion, passes through a lock hole formed in the R case 9 and engages with an engagement portion of the lock device 16, which will be described later, to lock the disk cover 1.

In the state wherein the optical disk 15 is attached to the attachment portion 18a, a broken line Q indicating the height of a front end portion of the lock device 16 is below a broken line P indicating the height of an end portion 15a in the upper part of the optical disk 15. Preferably, the broken line Q is disposed at a position as high as possible below the broken line P. Further, the hook 17b on the front end portion of the hook plate 17 is also below the broken line P. Preferably, it is disposed at a position as high as possible below the broken line P.

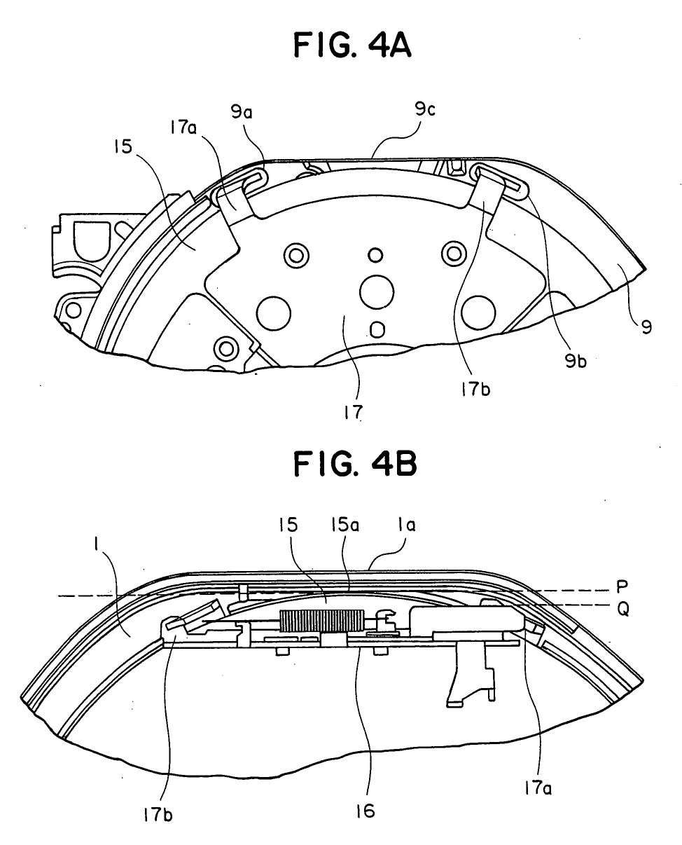

The arrangement of the lock mechanism will be further described with reference to FIGS. 4. FIG. 4A is the enlarged view of the lock mechanism of the video camera according to this embodiment as viewed from the dick cover 1 side. FIG. 4B is the enlarged view of the lock mechanism of the video camera according to this embodiment as viewed from the R case 9 side.

A hook 17a and the hook 17b for engagement with the lock device 16 are formed on the front end portion of the hook plate 17. To cover the optical disk 15, the respective hooks pass through a lock hole 9a and a lock hole 9b formed on the R case 9 and engage with engagement portions of the lock device 16 disposed on the back face of the R case 9, which will be described later, to lock the disk cover 1 fixed to the hook plate 1.

The lock device 16 is arranged such that the broken line Q indicating the height of the front end portion of the lock device 16 is below the broken line P indicating the height of the front end portion 15a in the upper part of the optical disk 15. Further, front end portions of the hooks 17a and 17b of the hook plate 17 are also situated such that their heights are below the broken line P. Because the positions of the hooks 17a and 17b and the lock device 16 for locking the disk cover 1 are thus lower than the front end portion 15a of the optical disk 15, the heights of the disk cover 1 and the R case 9, that is, the height of the video camera main body can be lowered by forming an upper end portion 1a of the disk cover 1 and an upper end portion 9c of the R case 9 in substantially linear shapes along a tangent to the contour of the optical disk 15.

In addition, since the positions of the hooks 17a and 17b and the lock device 16 are set as close to the broken line P as possible, and since the distance between the hooks is set short, the disk cover 1 does not open by its own weight to make a gap between the upper end portion 1a of the disk cover 1 and the upper end portion 9c of the R case 9. Therefore, dirt and dust can be prevented from entering though a gap, and its appearance is desirable.

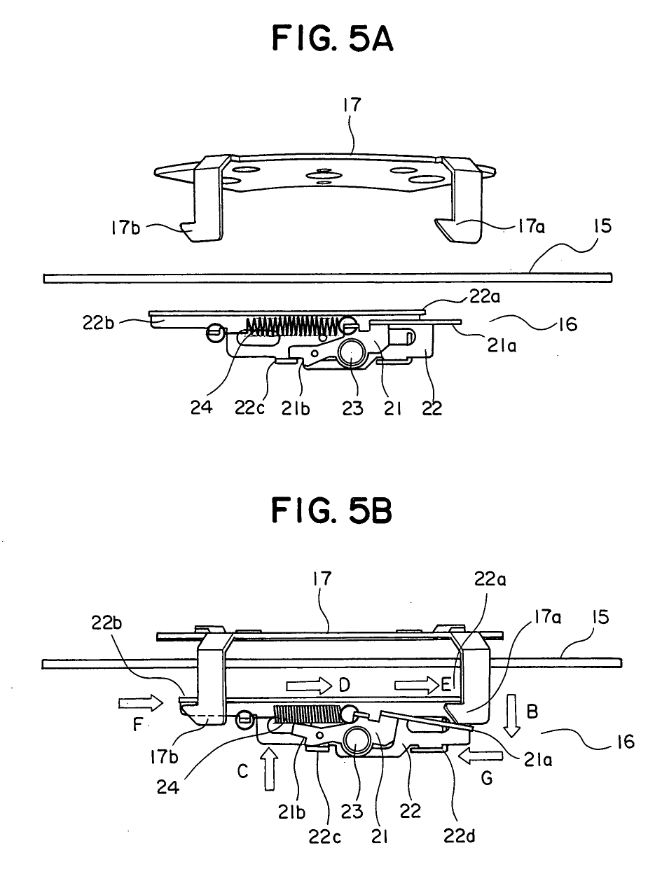

The detailed construction and operation of the lock mechanism will be now described with reference to FIG. 5. FIG. 5A is the upper view of the lock mechanism with the hook plate 17 opened. FIG. 5B is the upper view of the lock mechanism with the hook plate 17 closed. FIG. 5 show a state that the disk cover 1 has been detached.

The hook plate 17 has on its front end portion the hook 17a and the hook 17b for engaging with the engagement portions of the lock device 16. The lock device 16 is comprised of an inhibit 21, a lock slider 22, a lock slider pin 23 and a lock spring 24.

In a state wherein the disk cover 1 is opened, that is, in a state that the lock is released, the inhibit 21 is supported by the lock slider 22 and the lock slider pin 23. The lock spring to which the inhibit 21 and the lock slider 22 are connected is in a state of extension. An inhibit engagement portion 21b is engaged with a lock slider engagement portion 22c and keeps the state. In this state, a lock slider engagement portion 22a and a lock slider engagement portion 22b stay leftward of the hooks 17a and 17b of the hook plate 17.

When a user is closing the disk cover 1, the hook 17a of the hook plate pushes a face of an inhibit contact portion 21a so that the inhibit 21 rotates in a B direction with the lock slider pin 23 serving as a fulcrum. During the inhibit 21 rotates in the B direction with the lock slider pin 23 serving as the fulcrum, the inhibit engagement portion 21b overrides the lock slider engagement portion 22c and rotates in a C direction. By the rotation in the C direction, engagement between the inhibit engagement portion 21b and the lock slider engagement portion 22c is released, and the tension of the lock spring 24 is released. By the contraction force, the lock spring 24 contracts in a D direction. The lock slider engagement portion 22a and the lock slider engagement portion 22b are pulled in an E direction and an F direction, respectively, and they are then engaged with the hooks 17a and 17b of the hook plate 17, respectively, thereby locking the disk cover 1.

When the user operates the takeout knob 14 to take out the optical disk 15, a lock slider piece 22d moves in a G direction by rotation of a motor (not shown) attached to the lock device 16, with transmission of a cam gear (not shown). The engagement between the lock slider engagement portions 22a and 22b and that between the hooks 17a and 17b of the hook plate 17 are released, and the disk cover 1 fixed to the lock plate 1 is opened. In addition, because of releasing of the engagement between the lock slider engagement portion 22a and the hook 17a of the hook plate 17, the inhibit contact portion 21a rotates in a reverse direction of the B direction. The inhibit engagement portion 21b also rotates in a reverse direction of the C direction. The inhibit engagement portion 21b is then engaged with the lock slider engagement portion 22c and kept in this state.

This allows the height of the camera main body to be lowered by the height corresponding to the lock mechanism, and thus a decrease in height of the video camera can be realized. In addition, the open and close cover is locked at the plurality of positions, and a gap is hardly made.

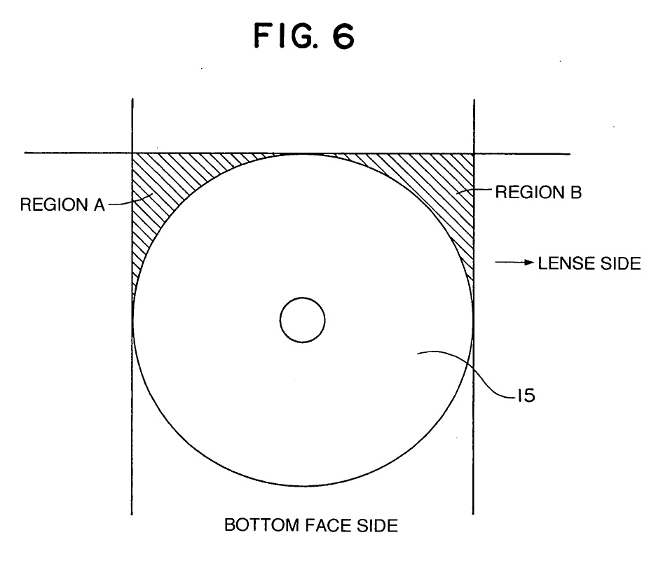

FIG. 6 shows a conceptual view of the embodiment. For the convenience of explanation, components unnecessary for the explanation are not shown.

FIG. 6 is the view of the video camera main body as viewed from the disk cover side. Therefore, the image taking system such as the lens exists on the right side toward the figure, and a battery and so on are arranged on the left side toward the figure. The lower side toward the figure is the bottom face side of the video camera, where the hinge mechanism and so on are disposed. Hatching regions A and B in the figure are regions surrounded by tangents extending on the outer periphery of the disk 15. These tangents are the tangent line extending on an upper point of the outer periphery of the disk 15, and the tangent line perpendicular to the former tangent line. In the embodiment, the lock mechanism is arranged in the hatching regions. More specifically, when the disk cover is closed, the hooks as the engagement portions provided on the disk cover engage with the lock mechanism in the form of the hole portions in the hatching region A or/and B. With this disposition of the hooks and the lock mechanism in the hatching regions, it is possible to provide a decrease in height and compactification of the video camera. Further, by disposing them as upward in the hatching regions A and B as possible, a gap of the disk cover by gravity can be prevented.

While we have shown and described the embodiment in accordance with our invention, it should be understood that the disclosed embodiment is susceptible of changes and modifications without departing from the scope of the invention. Therefore, we do not intend to be bound by the details shown and described herein but intend to cover all such changes and modifications a fall within the ambit of the appended claims.

1. A video camera for recording video information on a disk, comprising:
an attachment portion to which the disk is attached;
a protective portion to protect the disk;
a fulcrum portion when the protective portion is opened and closed;
two engagement portions provided on the protective portion; and
two hole portions to receive the engagement portions,
the disk being disposed at a position overlapping a straight line which extends between the two engagement portions.

2. The video camera according to claim 1, wherein the disk is vertically disposed on a side face of the video camera.

3. The video camera according to claim 2, wherein the fulcrum portion is disposed on a bottom face of the video camera.

4. The video camera according to claim 3, wherein the engagement portions are disposed on an opposite side of the attachment portion to the fulcrum portion.

5. A video camera for recording video information on a disk, comprising:
an attachment portion to which the disk is attached;
a protective portion to protect the disk;
a fulcrum portion when the protective portion is opened/closed;
two engagement portions provided on the protective portion; and
two hole portions to receive the engagement portions,
the disk being disposed at a position overlapping a straight line which extends between the two hole portions.

6. The video camera according to claim 5, wherein the disk is vertically disposed on a side face of the video camera.

7. The video camera according to claim 6, wherein the fulcrum portion is disposed on a bottom face of the video camera.

8. The video camera according to claim 7, wherein the hole portions are disposed on an opposite side of the attachment portion to the fulcrum portion.

9. A video camera having a drive device to mount an optical disk, an open and close cover to be opened and closed using a hinge mechanism when the optical disk is exchanged, and a lock mechanism comprised of a plurality of lock hooks and one or more lock devices to lock the open and close cover, wherein a position of the lock mechanism is equal to or lower than a height of an end face of the optical disk on a side opposite to the hinge mechanism when the optical disk is mounted to the drive device.

10. The video camera according to claim 9, wherein the lock mechanism is comprised of the two lock hooks protruding from a member on an open and close cover side, and the lock device provided on a drive device side and having engagement portions to engage with the two lock hooks, and
positions of the two lock hooks and the lock mechanism are equal to or lower than the height of the end face of the optical disk on the side opposite to the hinge mechanism when the optical disk is mounted to the drive device.

11. The video camera according to claim 9 or 10, wherein the hinge mechanism is disposed on a bottom face of the video camera.

12. A video camera for recording video information on a disk, comprising:
a protective portion to protect the disk;
a fulcrum portion when the protective portion is opened and closed;
an engagement portion provided on the protective portion; and
a hole portion to receive the engagement portion,
the hole portion being disposed in a region surrounded by:
an outer periphery of the optical disk;
a first tangent extending on an upper point of the outer periphery of the optical disk; and
a second tangent perpendicular to the first tangent and extending on the outer periphery of the optical disk.
